(19) United States
(12) Patent Application Publication
(10) Pub. No.: US 2025/0252616 A1
(43) Pub. Date: Aug. 7, 2025

(54) Split Rendering With Local Rendering Of Interactive Objects

(71) Applicant: Nokia Technologies Oy, Espoo (FI)

(72) Inventors: Saba Ahsan, Rawalpindi (PK); Gazi Karam Illahi, Helsinki (FI); Serhan Gül, Berlin (DE); Igor Danilo Diego Curcio, Gravina di Catania (IT); Jaakko Olli Taavetti Keränen, Helsinki (FI)

(21) Appl. No.: 19/041,295

(22) Filed: Jan. 30, 2025

Related U.S. Application Data
(60) Provisional application No. 63/548,623, filed on Feb. 1, 2024.

(51) Int. Cl. G06T 11/00; G06F 3/01; H04L 65/1069; H04L 65/1108; H04L 65/65; H04L 65/70

(52) U.S. Cl. CPC G06T 11/00; G06F 3/013; G06F 3/017; H04L 65/1069; H04L 65/1108; H04L 65/65; H04L 65/70; G06T 2210/36; G06T 2210/61

(57) ABSTRACT

An apparatus includes at least one processor; and at least one memory storing instructions that, when executed by the at least one processor, cause the apparatus at least to: determine a radius of a sphere centered at a virtual camera that has a correspondence to the apparatus; wherein preferential rendering is used for objects within the sphere defined with the radius; wherein remote rendering is used for objects outside the sphere defined with the radius; and draw on a display the objects within the sphere and objects outside the sphere, based on the objects being used for preferential rendering and remote rendering.

### RELATED APPLICATION

This application claims priority to U.S. Provisional Application No. 63/548,623, filed Feb. 1, 2024, which is herein incorporated by reference in its entirety.

### TECHNICAL FIELD

The examples and non-limiting example embodiments relate generally to multimedia transport and, more particularly, to split rendering with local rendering of interactive objects.

### BACKGROUND

It is known for a communication device to display information to a user of the communication device.

### SUMMARY

In accordance with an aspect, an apparatus includes at least one processor; and at least one memory storing instructions that, when executed by the at least one processor, cause the apparatus at least to: determine a radius of a sphere centered at a virtual camera that has a correspondence to the apparatus; wherein preferential rendering is used for objects within the sphere defined with the radius; wherein remote rendering is used for objects outside the sphere defined with the radius; and draw on a display the objects within the sphere and objects outside the sphere, based on the objects being used for preferential rendering and remote rendering.

In accordance with an aspect, an apparatus includes at least one processor; and at least one memory storing instructions that, when executed by the at least one processor, cause the apparatus at least to: receive a split rendering configuration message with at least one offered value for split rendering; determine at least one value for the split rendering; and transmit a rendering description message comprising the at least one value for the split rendering; wherein the at least one value for the split rendering comprises at least one radius of a sphere centered at a virtual camera that has a correspondence to a client device; wherein preferential rendering is used for objects within the sphere defined with the at least one radius; wherein remote rendering is used for objects outside the sphere defined with the at least one radius.

In accordance with an aspect, an apparatus includes at least one processor; and at least one memory storing instructions that, when executed by the at least one processor, cause the apparatus at least to: receive, from a client, a split rendering configuration message with at least one offered value for split rendering; forward, to a server, the split rendering configuration message with the at least one offered value for split rendering; wherein the at least one offered value for the split rendering comprises at least one offered radius of a sphere centered at a virtual camera that has a correspondence to a client device; receive, from the server, a rendering description message comprising at least one value for the split rendering; and forward, to the client, the rendering description message comprising the at least one value for the split rendering; wherein the at least one value for the split rendering comprises at least one radius of a sphere centered at the virtual camera that has a correspondence to the client device; wherein preferential rendering is used for objects within the sphere defined with the at least one radius; wherein remote rendering is used for objects outside the sphere defined with the at least one radius.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example of a split management architecture.

FIG. 3 shows an example user plane architecture for a split management architecture.

FIG. 4 is a call flow diagram depicting a SWAP message exchange for the establishment of a split rendering session.

FIG. 5 shows a 2-byte RTP header extension form used for signaling a rendered pose header extension.

FIG. 6 shows an illustration with a sphere with radius R.

FIG. 7 shows an illustration when two spheres S1 and S2 (planar equatorial view), with radii R1 and R2 are used.

FIG. 8 shows the case when a restricted FoV is used with S.

FIG. 9 is a call flow that shows a split rendering session setup using the configuration parameters R, R1, etc. as described herein.

FIG. 10 is an example apparatus configured to implement the examples described herein.

FIG. 11 shows a representation of an example of non-volatile memory media used to store instructions that implement the examples described herein.

FIG. 12 is an example method, based on the examples described herein.

FIG. 13 is an example method, based on the examples described herein.

FIG. 14 is an example method, based on the examples described herein.

### DETAILED DESCRIPTION OF EXAMPLE EMBODIMENTS

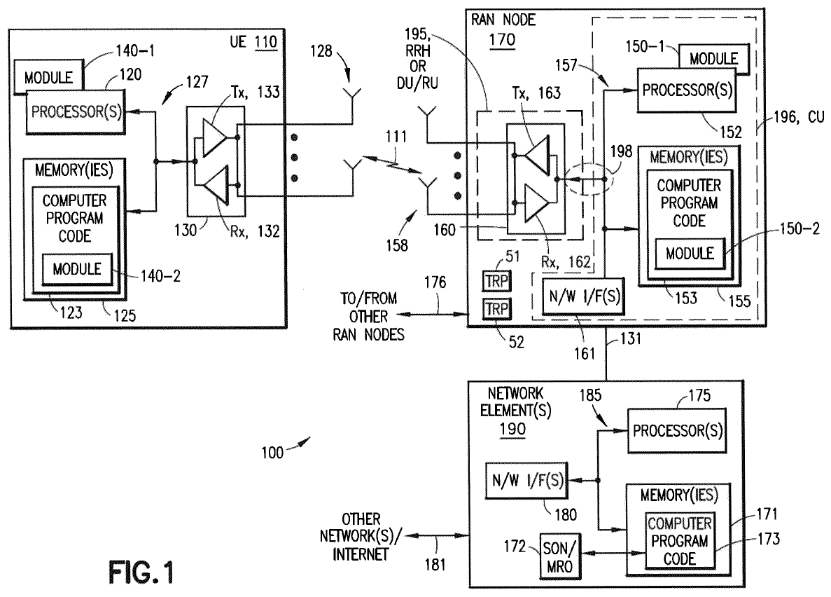

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

Split rendering Media Service Enabler is defined in 3GPP TS 26.565. The Split Rendering Media Service Enabler collects a set of 5G media functions to build a media service enabler that targets application developers, network operators, and application service providers, to enable the realization of split rendered applications.

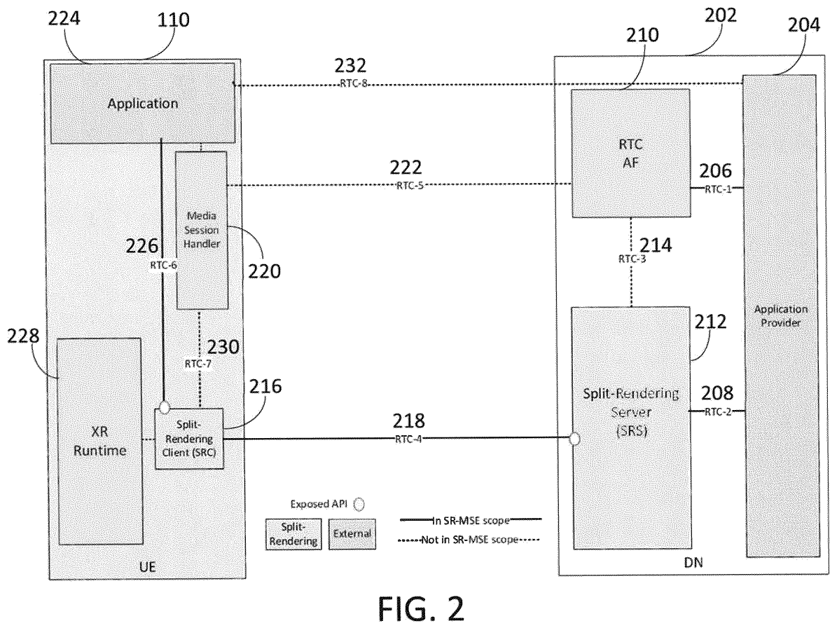

FIG. 2 shows an example split management architecture. As shown in FIG. 2: 1. The 5G Application Provider (AP) 204, within data network 202, provisions the split-rendering through RTC-1 206. 2. In the use cases in which the AP 204 is involved in the media delivery, the RTC-2 interface 208 is used for this purpose. 3. The communication between Application Function (AF) 210 and Split Rendering Server (SRS) 212 is through RTC-3 214. This interface (RTC-3 214) may for instance include the EDGE-3 interface. 4. The signaling as well as the media delivery between Split Rendering Client (SRC) 216 and SRS 212 is though RTC-4 218. 5. The AF 210 may provide the split-rendering information to the Media Session Handler 220 defined by RTC-5 222, defined in TS26.506. 6. SRC 216 in the UE 110 discovers the application 224 through RTC-6 226 and handles the XR runtime 228. 7. The SRC 216 discovers the client media capabilities through the RTC-7 interface 230. 8. The 5G Application 224 and AP 204 interact through RTC-8-8 232. Application 224 and application provider 204 may be considered external.

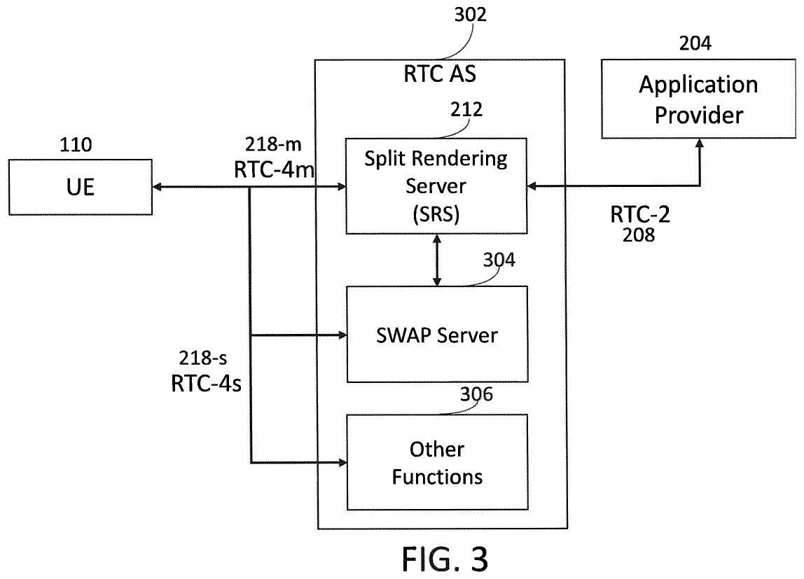

FIG. 3 shows an example user plane architecture for split management architecture. The SR interfaces are considered to be specializations of their parent RTC interfaces as defined in TS26.506. In the context of split rendering, the SR-4 interface 218 is further classified as SR-4s (218-s) and SR-4m (218-m) sub-interfaces. The SR-4s (218-s) interface covers all user-plane signaling, including WebRTC and ICE signaling. The SR-4m (218-m) serves for media and metadata exchange between the split rendering client 216 and the split rendering server 212. As shown in FIG. 3, the RTC AS 302 includes SWAP server 304 and other functions 306.

The SWAP protocol allows for the definition of application-specific messages. For Split Rendering, the following application-specific messages shall be supported (1-2): 1. The configuration message carries the split rendering configuration information from the SRC 216 to the SRS 212. It shall be identified by the type “urn:3gpp:sr-mse:sr-configuration” and the object shall be formatted according to clause 8.4.2.2. 2. The rendering description message carries the description of the split rendered media from the SRS 212 to SRC 216. It shall be identified by the type “urn:3gpp:sr-mse:sr-description” and the object shall be formatted according to clause 8.4.3. The rendering description message provides the semantics of the media that is delivered over WebRTC from the SRS 212 to SRC 216.

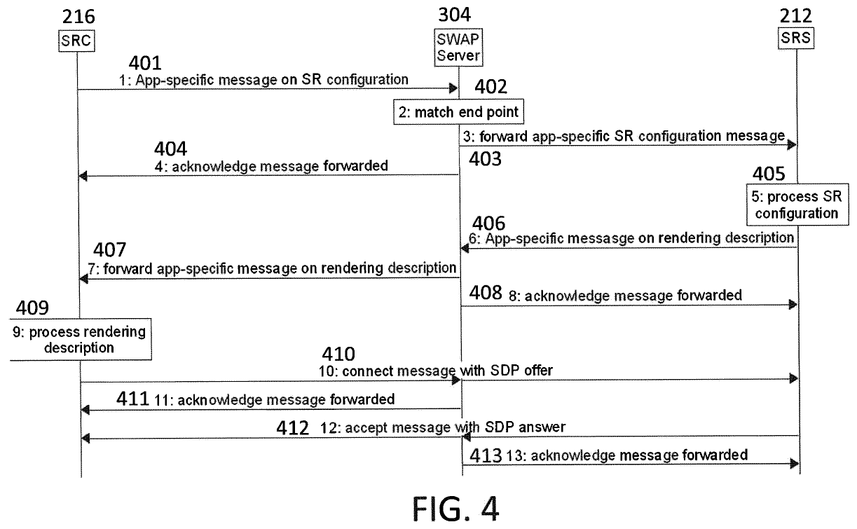

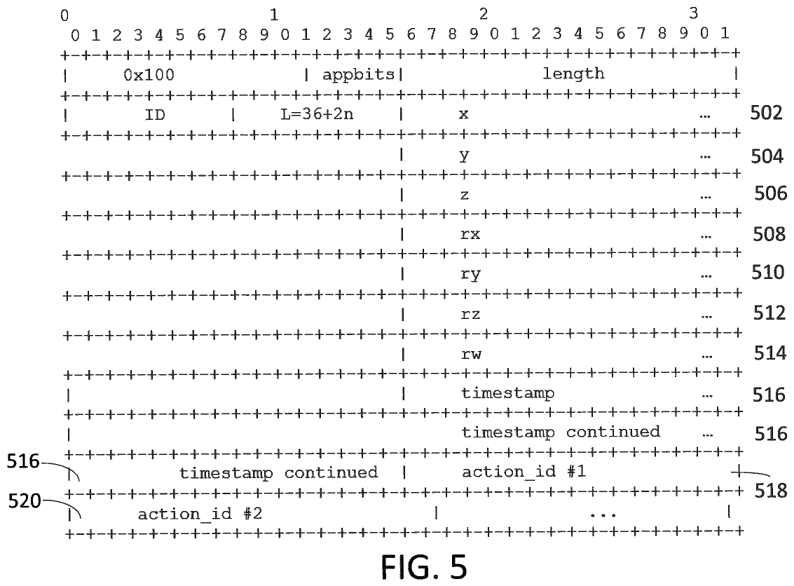

The SWAP message exchange for the establishment of a split rendering session is depicted by the call flow diagram of FIG. 4 that shows the signaling exchange between SRC 216, SWAP server 304, and SRS 212

In the call flow diagram of FIG. 4, it may be assumed that the SRC 216 has discovered the identifier of the SRS 212 that the SRC 216 uses for its split rendering session, and the SRC 216 has retrieved the address of the SWAP server 304 as part of the configuration. The operations are as follows:

1 (401). The SRC sends the configuration message as an application-specific SWAP message to the SWAP server. It provides the identifier of the target SRS as a matching criteria.

2 (402). The SWAP server uses the provided matching criteria to locate the SRS.

3 (403). The SWAP server forwards the configuration message to the target SRS.

4 (404). The SWAP server confirms the successful forwarding of the message to the SRC

5 (405). The SRS processes the SR configuration message. It may for instance verify application and resource availability, launch the application, configure its rendering, and create a rendering description.

6 (406). The SRS sends the rendering description message as an application-specific SWAP message to the SWAP server.

7 (407). The SWAP server forwards the message to the SRC.

8 (408). The SWAP server acknowledges the successful forwarding of the message to the SRS.

9 (409). The SRC processes the rendering description and identifies the required data channel and media sessions.

10 (410). SRC sends a connect message with the SDP offer to the SRS. The offer reflects the negotiated media and data channel streams.

11 (411). The SWAP server acknowledges the forwarding of the message to the SRS

12 (412). The SRS replies with an accept message that includes the SDP answer. The SDP answer reflects the information that was provided in the split rendering description.

13 (413). The SWAP server acknowledges the forwarding of the message to the SRC.

The Split Rendering client establishes an XR session locally based on the device configuration and user selection. The SR client defines the view configuration (e.g. mono or stereo views), the projection format (such as projection, equirectangular, quad, or cubemap), the swap chain image configuration, etc.

In addition, XR space and action configurations are negotiated between the SR client and server. This includes defining common XR spaces and defining and selecting actions and action sets. The session configuration information may be in JSON format. The session configuration information may have the following format:

| Name | Type | Cardinality | Description |
|---|---|---|---|
| renderingFlags | Array(SR_CONFIG_FLAGS) | 0 . . . 1 | Provides a set of flags to |
| | | | activate/deactivate selected |
| | | | rendering functions. The |
| | | | defined |
| | | | SR_CONFIG_FLAGS are: |
| | | | FLAG_ALPHA_BLENDING |
| | | | FLAG_DEPTH_COMPOSITION |
| | | | FLAG_EYE_GAZE_{—} |
| | | | TRACKING |
| | | | FLAG_ADAPTIVE_{—} |
| | | | SPLIT_RENDERING |
| spaceConfiguration | Object | 0 . . . 1 | The space configuration is |
| | | | typically sent by the split |
| | | | rendering server to the split |
| | | | rendering client. Upon |
| | | | reception of this |
| | | | information, the SR client |
| | | | uses this information to |
| | | | create the reference and |
| | | | action spaces as well as to |
| | | | agree on common identifiers |
| | | | for the XR spaces. |
| referenceSpaces | Array | 0 . . . 1 | An array of reference spaces |
| | | | and their identifiers. |
| id | number | 1 . . . 1 | A unique identifier of the |
| | | | XR space in the context of |
| | | | the split rendering session. |
| refSpace | enum | 1 . . . 1 | One of the defined reference |
| | | | spaces in OpenXR. These |
| | | | may be: |
| | | | XR_REFERENCE_SPACE_{—} |
| | | | TYPE_VIEW, |
| | | | XR_REFERENCE_SPACE_{—} |
| | | | TYPE_LOCAL, or |
| | | | XR_REFERENCE_SPACE_{—} |
| | | | TYPE_STAGE. |
| actionSpaces | Array | 0 . . . 1 | An array of action spaces |
| | | | that need to be defined by |
| | | | the split rendering client in |
| | | | the XR session. |
| id | number | 1 . . . 1 | A unique identifier of the |
| | | | XR space in the context of |
| | | | the split rendering session. |
| actionId | number | 1 . . . 1 | Provides the unique |
| | | | identifier of the action. |
| subactionPath | string | 1 . . . 1 | The subaction path |
| | | | identifies the action, which |
| | | | can then be mapped by the |
| | | | XR runtime to user input |
| | | | modalities. |
| initialPose | Pose | 0 . . . 1 | Provides the initial pose of |
| | | | the new XR space's origin. |
| viewConfiguration | Object | 0 . . . 1 | Conveys the view |
| | | | configuration that is |
| | | | configured for the XR |
| | | | session. |
| type | Enum | 1 . . . 1 | The type indicates the view |
| | | | configuration. Defined |
| | | | values are MONO and |
| | | | STEREO. Other values may |
| | | | be added. |
| width | number | 1 . . . 1 | The recommended width of |
| | | | the swapchain image. |
| height | number | 1 . . . 1 | The recommended height of |
| | | | the swapchain image. |
| compositionLayer | string | 1 . . . 1 | An identifier of the selected |
| | | | composition layer. |
| environmentBlend | enum | 1 . . . 1 | The type indicates the |
| Mode | | | environment blend mode |
| | | | configuration. Defined |
| | | | values are OPAQUE, |
| | | | ADDITIVE and |
| | | | ALPHA_BLEND. Other |
| | | | values may be added. |
| actionConfiguration | Array | 0 . . . 1 | This contains a list of the |
| | | | actions that are to be |
| | | | defined by the SR client. |
| action | Object | 1 . . . n | A definition of a single |
| | | | action object. |
| id | number | 1 . . . 1 | A unique identifier of the |
| | | | action. |
| actionType | enum | 1 . . . 1 | The type of the action state. |
| | | | This can be a Boolean, float, |
| | | | vector2, pose, vibration |
| | | | output, etc. |
| subactionPaths | string | 1 . . . n | An array of subaction paths |
| | | | associated with this action. |
| | | | The split rendering client |
| | | | will provide the state of all |
| | | | defined sub-action paths. |
| extraConfigurations | Object | 0 . . . 1 | A placeholder for addition |
| | | | configuration information. |

### Split Rendering Adaptation

During a split rendering session, the operating environment of the split rendering server, the split rendering client or the network conditions may change. Consequently, the rendering split may need to be adapted to deliver a consistent QoE. When true adaptive split rendering is enabled, the SRS or SRC may request a new rendering split by sending a SWAP message of the type “urn:3gpp:split-rendering:v1:sr-split”. The same message type may be used to acknowledge, accept or reject the request by the receiver. An example message format used by the SRS to request a new rendering split, or used by the receiver to acknowledge, accept, or reject the request for the new rendering split, is as follows:

| Name | Type | Cardinality | Description |
|---|---|---|---|
| id | string | 1 . . . 1 | A unique identifier of the |
| | | | message in the scope of the data |
| | | | channel session. |
| type | string | 1 . . . 1 | |
| message | Object | 1 . . . 1 | Message content |
| subtype | string | 1 . . . n | An identifier of the subtype |
| | | | of the message, it may be a |
| | | | request or new split or |
| | | | acknowledgement, acceptance |
| | | | or rejection of a request |
| renderingSplit | Object | 1 . . . 1 | An JSON object identifying |
| | | | objects to be rendered and where |
| | | | they are to be rendered (SRS or |
| | | | SRC), for example, as a |
| | | | dictionary with keys “SRS” and |
| | | | “SRC” and lists of object indices |
| | | | from a scene description or a |
| | | | scene graph |

### RTP Header Extension for Rendered Pose

A server that uses RTP to deliver pre-rendered video streams to a UE should include an RTP header extension for the rendered pose to indicate the pose used for rendering the media. The rendered pose RTP header extension may also be used with audio streams. The carriage of the information below via a RTP header extension is provided as an example. The same information could be transmitted over different protocols or over RTP using other packet syntax elements (e.g., RTCP APP packets in sender reports).

An RTP client that supports the RTP header extension for rendered pose shall negotiate the use the of the extension using SDP with the “extmap” attribute as defined in RFC8285 with the following URN: “urn:3gpp:xr-rendered-pose”. The syntax for the extmap attribute shall conform to the following ABNF syntax:

$$extmap - attr = {}^{‶} a = extmap {:}^{″} ⋆ 5 DIGIT {[}^{‶} {/}^{″} direction ] SP$$

$${‶}^{} urn : 3 gpp : xr - rendered - {pose}^{″} [ {SP}^{‶} media {:}^{″} 1 ⋆ ( SP token ) ]$$

The direction shall be defined as in RFC8285. The extension attribute “media” is followed by a list of tokens for “mid” (as defined in RFC 5888) for media streams that can reuse the rendered pose included in the RTP header extension. Further details on reuse are provided later in the section. SP is space in BNF notation defined in RFC 5234.

An RTP client that supports the RTP header extension for rendered pose and receives an SDP offer with “a-extmap” attribute with the URN: “urn:3gpp:xr-rendered-pose” shall remove the attribute from the answer for any media that will not use the extension, and retain it for any media that will use it.

The server delivers the rendered frames using one or more video streams, depending on the view and projection configuration that is selected by the UE. The server should use the RTP header extension for rendered pose to associate the selected pose with the rendered frame.

If negotiated successfully, an RTP sender should add the RTP header extension for rendered pose in the RTP stream. The frequency of RTP header extension for rendered pose shall be at least once in a frame. It may be sent more often but not necessarily in every RTP packet.

The 2-byte (RFC8285) RTP header extension format shall be used for signaling the rendered pose header extension as follows:

x (32 bits): x coordinate of the position of the rendered pose in meters (502).

y (32 bits): y coordinate of the position of the rendered pose in meters (504).

z (32 bits): z coordinate of the position of the rendered pose in meters (506).

rx (32 bits): x coordinate of the orientation quaternion of the rendered pose (508).

ry (32 bits): y coordinate of the orientation quaternion of the rendered pose (510).

rz (32 bits): z coordinate of the orientation quaternion of the rendered pose (512).

rw (32 bits): w coordinate of the orientation quaternion of the rendered pose (514).

The XR server should be aware of the XR space used by the XR client for the pose fields defined above. Signaling aspects for this XR space may be implemented.

timestamp (64 bits): Timestamp (516) that corresponds to the predicted time for the pose. This timestamp uses the XR system clock. There is no requirement to synchronize the timestamps of the RTP stream to the XR system clock. The timestamp is passed to the XR runtime together with the rendered swapchain images (e.g. as part of the xrEndFrame call in OpenXR).

action_id (32 bits): A list of actions that were processed for the rendering of the frame are listed using action identifiers. The number of action identifiers (518, 520) in one RTP header extension for rendered pose shall be no more than 10. Hence, the maximum size of the header extension is 36+2*n, where n is the number of action identifiers in the header extension.

When both video and audio are delivered to the UE, or when either audio or video is delivered using multiple real-time streams (e.g., left eye+right eye), multiple RTP streams may be associated with the same header extension data, e.g., the same pose may have been used for generating multiple streams. This may lead to sending the same header extension data multiple times in different streams.

Targets in XR (e.g. objects identified by gaze tracking) may be defined and signaled between the SRC and SRS and other UEs, and the SRS may render them at a higher quality. A negotiation of split rendering configuration may be defined between an SRC and an SRS. However, this negotiation of split rendering configuration does not take into account low-latency requirements of interactive/transparent objects with seamless adaptation. A scene may be divided into different 2D composition layers that have different time warp sensitivity while assuming the SRC has the capability to apply these different levels of time warping. Adaptive split rendering may be defined with a trigger to renegotiate the rendering split between the split rendering server and the split rendering client, however this adaptive split rendering does not take into account interactive, reflective objects or a distance parameter. Azure remote rendering (ARR) and reprojection pose modes may also be implemented. Efficient scenery object rendering may include defining a level of detail (LOD) for rendered spatial regions of a frame, or rendered tiles, based on their distance from a viewpoint, however such efficient scenery object rendering makes no differentiation for rendering specific objects (e.g., interactive objects) dynamically at the client to reduce effects from inefficient prediction and reprojection.

In split/remote rendering process pose prediction is used to compensate for latency. Furthermore, reprojection techniques are used to correct pose prediction errors. However, certain objects (e.g., interactive, transparent) are difficult to apply prediction techniques on and reprojection is challenging, which can be further exacerbated in high latency conditions. Users are more likely to notice these problems when the objects are placed near them.

For XR scenarios, objects with transparent or reflective parts may benefit from realistic lighting computed by the XR device. Remote rendering services like ARR typically use a sky texture to light objects and provide built-in environment maps to simulate different lighting conditions. For transparent or reflective objects, rendering using more dynamic and realistic lighting information may be needed, which is only available to the XR device.

Currently there is no way to signal/negotiate an area in the scene between a split rendering client and server for which a preferential rendering can be used for such objects to minimize the effects of motion-to-render latency. Furthermore, since various techniques can be used for preferential rendering, there is no signaling defined for what technique will be used.

The examples described herein relate to an adaptive split rendering setup with preferential rendering for specific objects (e.g., rendering locally at the client) when requirements based on the following negotiable parameters are met (1-4):

1. A distance R in meters that defines the radius of a sphere S centered at the UE, such that, certain objects lying within this sphere will have a preferential rendering profile.

2. Two distances R1 and R2 (e.g., in meters), such that R1 and R2 are the radii of two spheres S1 and S2, respectively, that are centered at the UE; such that, certain objects positioned within S1 have a preferential rendering profile when a condition is false, and certain objects positioned within S2 have a preferential rendering profile when the condition is true. One such condition may be focused viewing, where gaze tracking is used to determine when an object is focused or unfocused. When the user's gaze intersects an object, it is considered focused, otherwise the object is unfocused. If eye tracking is enabled on the UE, then S1 is used during unfocused viewing and S2 is used during focused viewing.

3. With any of the distances R, R1, or R2, further defining a restricted Field of View (FoV) such that only certain objects within the restricted FOV and S, S1 or S2 have a preferential rendering. The restricted FoV may be defined based on, e.g., user gaze, application state (e.g., actions/pose of another user in a shared XR experience), environment conditions (e.g., position of sources of light, movement of objects). The restricted FoV does not have to be centered at the device FoV.

4. The type of preferential rendering to be used.

The SRC and SRS exchange split rendering configuration parameters such as decoding capabilities over, e.g., SIP/SDP or SWAP protocol. The media rendered by the SRS is delivered to the SRC, for example, over RTP or a WebRTC/MTSI data channel. If needed, the SRC sends pose, action metadata to the SRS over a data channel, RTP or other protocol. To cater for high latency, pose prediction errors or inefficient reprojection, some objects in an XR scene can be rendered with a preferred rendering profile.

An entity in a split rendering service, e.g., SRC or SRS, may indicate as part of their configuration (1-3):

1. A distance R in meters that defines the radius of a sphere S centered at the UE, such that, certain objects lying within this sphere will have a preferential rendering profile.

2. Two distances R1 and R2 in meters, such that R1 and R2 are the radii of two spheres S1 and S2, respectively, that are centered at the UE; such that, certain objects positioned within S1 have a preferential rendering profile when a condition is false, and certain objects positioned within S2 have a preferential rendering profile when the condition is true. One such condition may be focused viewing. If eye tracking is enabled on the UE, then S1 is used during unfocused viewing and S2 is used during focused viewing.

3. With any of the distances R, R1, or R2, further defining a restricted Field of View (FoV) such that only certain objects within the restricted FoV and S, S1 or S2 have a preferential rendering. The restricted FoV may be defined based on, e.g., user gaze, application state (e.g., actions/pose of another user in a shared XR experience), environment conditions (e.g., position of sources of light, movement of objects). The restricted FoV does not have to be centered at the device FoV.

Objects that are selected for preferential rendering are XR objects that have low prediction accuracy, i.e., pose prediction and reprojection techniques are not enough to make up for the motion-to-render-to-photon latency when using remote rendering. These objects for example include interactive objects that react to user actions, pose, eye gaze, stimuli in the environment, etc., Objects with high reflectivity, especially in the presence of motion in the environment, such as, moving objects, changing light conditions, etc., and transparent objects.

A preferential rendering profile in split rendering may be defined as (the examples described herein relate to the signaling for which these schemes are used as defined herein): i) Objects with preferential rendering profile are rendered at the UE (local rendering), while all other objects are rendered at the SRS, ii) Objects with preferential rendering profile are rendered at the SRS as a composition layer with higher warp sensitivity, and/or iii) Objects with preferential rendering profile are rendered at a higher quality than others.

For convincing reflection effects, it is important for the server to provide an environment map to the client so the client can use it for shading its local objects. In practice, the client needs a (low-resolution) 360-degree cube map of the viewer's entire surroundings, with local objects omitted. The client may still need to locally augment this environment map with local objects in case they are prominently featured in reflections, for instance if they are very large or have bright light sources.

Transparent objects can be rendered as a separate composition layer. Appropriate time warping of this layer can achieve desired results at the UE.

The distances R, R1 and R2, and the restricted FOV can be defined by the application. The values can be negotiated between the client and the server. The following aspects can be taken into account when negotiating an appropriate value for R, R1, R2 and restricted FoV (1-2): 1. The number of objects in the scene, e.g., if there are too many interactive objects, a restricted FoV may be added to limit the number of objects that get rendered at the device. 2. The processing and rendering capabilities of the UE and the server.

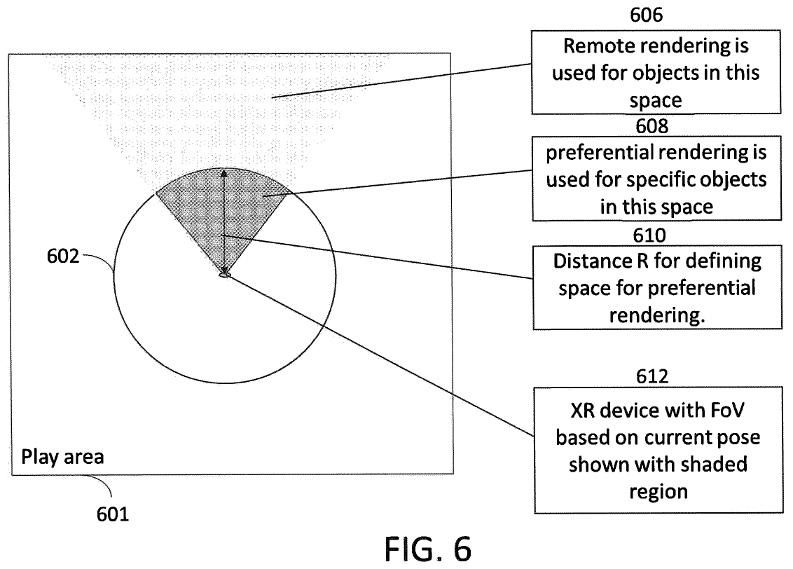

FIG. 6 shows an illustration with the sphere 602 with radius R 610. The XR device 612 is located within play area 601. Shown in FIG. 6 is region 606 and region 608. Remote rendering is used for objects within region or space 606. Preferential rendering is used for specific objects within region or space 608.

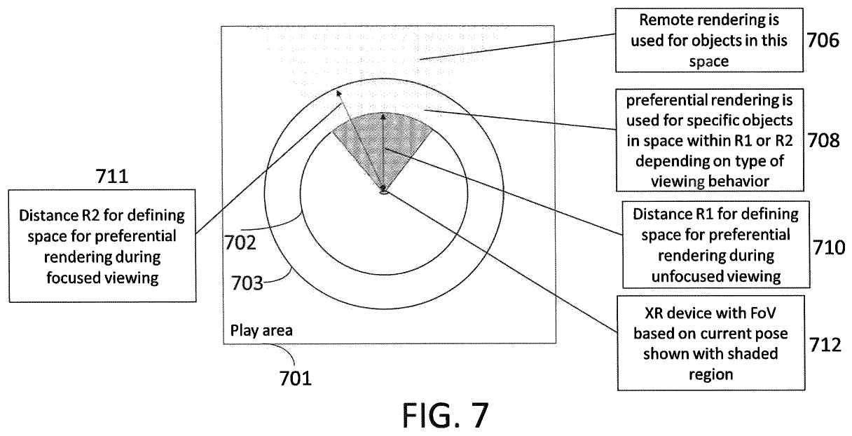

FIG. 7 shows an illustration when two spheres S1 702 and S2 703 (planar equatorial view), with radii R1 710 and R2 711 are used. The XR device 712 is located within play area 701. Shown in FIG. 7 is region 706 and region 708. Remote rendering is used for objects within region or space 706. Preferential rendering is used for specific objects within region or space 708, where space 708 is within R1 or R2 depending on the type of viewing behavior.

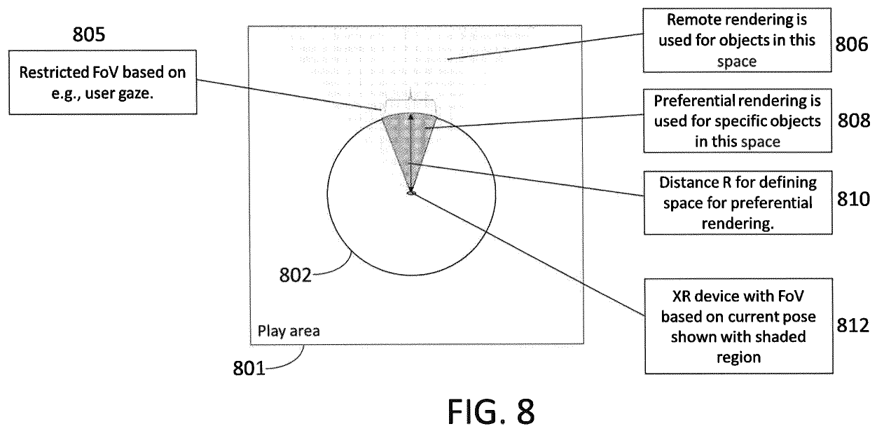

FIG. 8 shows the case when a restricted FoV 805 is used with sphere S 802. The XR device 812 is located within play area 801. Shown in FIG. 8 is region 806 and region 808. Remote rendering is used for objects within region or space 806. Preferential rendering is used for specific objects within region or space 808. Sphere 802 has radius 810.

Note that the restricted FoV can be used with S1 702 and S2 703, and in this case the restricted FoV that applies to S1 702 can be different from the restricted FoV that applies to S2 703. In each of FIG. 6, FIG. 7, and FIG. 8, the shaded area is the FoV of the device (612, 712, 812) as this is the portion which will be rendered; margins may be used during rendering (to allow for reprojection and compensating for errors in pose prediction) in which case the FoV shown here will be larger than the FoV of the device (612, 712, 812).

In an embodiment, only objects with a high-level of interaction are rendered at the UE. For example, objects that have predictable motion and slow response to actions are always rendered at the server. The level of interaction may stay the same throughout the session or change over time. Hence, it is possible that objects to be rendered at the UE or the SRS change over time. The level of interaction at any time can be determined by actions such as eye gaze, controller input, hand gestures, etc.

The following new parameters are defined:

| Name | Type | Description |
|---|---|---|
| renderingSplit | Object | A JSON object identifying objects to be rendered and |
| | | where they are to be rendered (SRS or SRC), for |
| | | example, as a dictionary with keys “SRS” and |
| | | “SRC” and lists of object indices from a scene |
| | | description or a scene graph. |
| | | When the preferential rendering is used, the list with |
| | | key “SRC” are objects with preferential rendering. |
| | | These can be rendered on the client, rendered as a |
| | | separate composition layer, rendered with higher |
| | | LOD, etc. |
| R | number | A distance R (e.g., in meters) that defines the sphere |
| | | S to be used for preferential rendering. |
| R1 | number | A distance R1 (e.g., in meters) that defines the sphere |
| | | S1 to be used for preferential rendering. |
| R2 | number | A distance R2 (e.g., in meters) that defines the sphere |
| | | S2 to be used for preferential rendering. |
| condition | string | A condition that when true would imply the sphere |
| | | S1 is used and when false sphere S2 is used for |
| | | preferential rendering. For example, the condition |
| | | can be the following flag |
| | | FLAG_EYE_GAZE_TRACKING |
| restricted FoV | Object | A restricted FoV may be defined with |
| | | vertical range (e.g. in radians) |
| | | a horizontal range (e.g., in radians). |
| | | The center of the FoV expressed e.g., as an |
| | | orientation (azimuth, elevation and rotation in |
| | | radians). The center of the FoV can be the |
| | | current orientation of the UE. The center of |
| | | FoV can be the current direction of the eye |
| | | gaze. |
| seamlessAdaptation | flag | In one embodiment, if the parameters R, R1, R2, or |
| | | restricted FoV are defined, then the adaptation is |
| | | seamless, i.e., the objects listed with key “SRC” in |
| | | renderingSplit will be rendered at SRC when |
| | | requirements for preferential rendering are met and |
| | | will be rendered at SRS when requirements for |
| | | preferential rendering are not met without the need |
| | | for any additional signaling between client and |
| | | server. This flag is set to TRUE when seamless |
| | | adaptation is used. |
| | | When set to false, the client and server may need to |
| | | have the appropriate signaling defined, e.g., RTP HE, |
| | | RTCP feedback, data channel. |
| preferentialRendering | string | Type of preferential rendering to be used. For |
| | | example, |
| | | LOCAL_RENDERING: The objects are |
| | | rendered on the client. |
| | | LOD_RENDERING: The objects are |
| | | rendered using models with higher LoD. |
| | | COMPOSITION_LAYER_RENDERING: |
| | | The objects are rendered as a separate |
| | | composition layer. It is possible to render all |
| | | objects with preferential rendering as a single |
| | | composition layer or as multiple composition |
| | | layers. Proper tagging for the composition |
| | | layers can be added. |

In an embodiment the above parameters are sent in the SWAP message for SR split with URN “urn:3gpp:split-rendering:v1:sr-split”. In another embodiment the parameters are sent as part of the split rendering configuration for the session.

In an alternative embodiment, the above parameters are SDP parameters defined as part of a session-level attribute a=renderingsplit [SP “R”=<value>] [SP “R1”=<value>] [SP “R2”=<value>] [SP “restrictedFov”=<value>] [SP “condition”=<value>] [SP FLAGS]. The flags may include the flag for seamless adaptation.

If seamless adaptation is used no further sr-split messages need to be sent during the session unless new objects that require preferential rendering are added to the scene.

When seamless adaptation is not used the client or server will signal the objects that currently meet the requirements for preferential rendering based on the defined parameters (e.g., R, R1, R2, restricted FoV).

The client may signal the objects IDs of objects that will be rendered locally with the feedback for pose and actions over the data channel or as RTCP feedback. The SRS would then know to not render the specific objects when it creates the rendering for that specific pose/action set. The server may signal the object IDs of objects that were rendered by the server in the RTP header extension for rendered pose. SWAP message for sr-split can be used but is potentially too slow for fast adaptation needs.

The following call flow shows a split rendering session setup using the configuration parameter R, R1, etc. defined and described herein. The client 216 may offer a range of these values for negotiation. The server 212 may then send chosen values for R, R1, etc. in a response in step 6 (906) and a list of object IDs that can be rendered at the client 216 when the requirements are met. In step 9 (909), the SRC 216 evaluates the rendering description and reserves appropriate resources for local rendering. In step 10 (910), the SRC 216 sets up the media channels for the remote rendered media. Additionally in step 10 (910), the SRC 216 can indicate that the object IDs to currently used for preferential rendering will be signaled in the Pose feedback and that it is capable of receiving an RTP HE with the object IDs from the server (e.g., as part of the rendered Pose RTP HE). In step 14 (914), the SRC 216 sends the pose feedback with the object IDs. In step 15 (915), the SRC 216 locally renders the objects that meet the requirements set by the negotiated values of R, R1, etc. In step 16 (916), the SRS 212 delivers the rendered media. The client 216 can then composite and display the output of step 15 (915) and 16 (916). Appropriate composition information can be signaled along with the rendered media when needed.

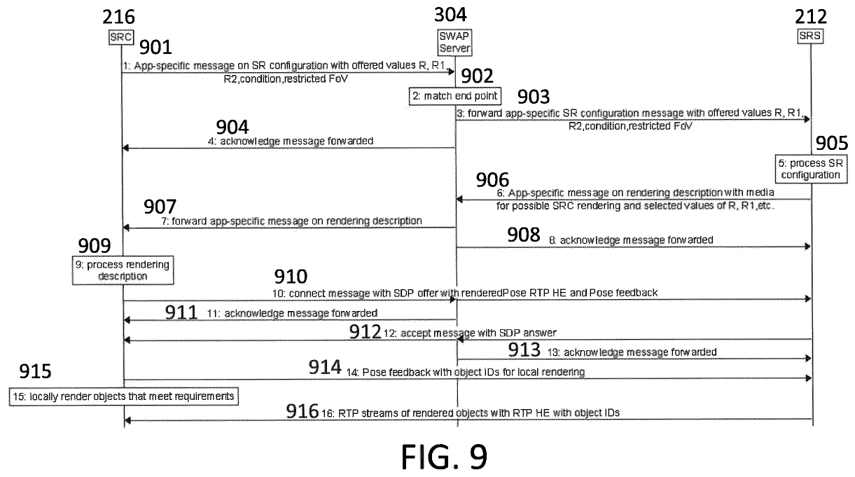

Thus, as shown in FIG. 9, at 901 the SRC 216 transmits to the SWAP server 304 an app specific message on an SR configuration with offered values R, R1, R2, a condition, and a restricted FOV. At 902, the SWAP server 304 matches an end point. At 903, the SWAP server 304 forwards to the SRS 212 the app specific SR configuration message with offered values R, R1, R2, the condition, and the restricted FOV. At 904, the SWAP server 304 transmits to the SRC 216 an acknowledgement that the message was forwarded. At 905, the SRS 212 processes the SR configuration. At 906, the SRS 212 transmits to the SWAP server 304 an app specific message on rendering description with media for possible SRC rendering and selected values of R, R1, etc. At 907, the SWAP server 304 forwards to the SRC 216 the app specific message on the rendering description. At 908, the SWAP server 304 forwards to the SRS 212 an acknowledgement that the app specific message on the rendering description was forwarded to the SRC 216.

At 909, the SRC 216 processes the rendering description. At 910, the SRC 216 transmits to the SWAP server 304 a connect message with an SDP offer with rendered pose RTP HE and pose feedback. At 910, the SWAP server 304 transmits to the SRS 212. At 911, the SWAP server 304 transmits to the SRS 212 the connect message with the SDP offer with rendered pose RTP HE and pose feedback that was received from the SRC 216 also at 910. At 911, the SWAP server 304 transmits to the SRC 216 an acknowledgement that the message received from the SRC 216 at 910 was forwarded to the SRS 212. At 912, the SRS 212 transmits to the SWAP server 304 an accept message with an SDP answer. Also at 912, the SWAP server 304 forwards to the SRC 216 the accept message with SDP answer. At 913, the SWAP server 304 transmits to the SRS 212 an acknowledgement that the accept message with SDP answer received from the SRS 212 was forwarded to the SRC 216. At 914, the SRC 216 transmits to the SRS 212 pose feedback with object IDs for local rendering. At 915, the SRC 216 locally renders objects that meet requirements. At 916, the SRS 212 transmits to the SRC 216 RTP streams of rendered objects with RTP HE with object IDs.

In an embodiment, all media may be delivered via SRS 212, which includes any media that will be locally rendered by the SRC 216 for the sake of synchronization. In this case, the media channels set up in steps 10-13 (namely 910, 911, 912, 913) will include the media channel for SRC 216 rendered objects.

In an embodiment, for moving objects in the space (or as soon as the UE 110 moves in the space), the distance of the UE from the objects is recalculated, and the split could be re-assigned and signaled based on the new positioning of the objects at a given point in time. In case optical or digital zoom is used to bring an object from a distance greater than R to a distance less than R, the split is recalculated and signaled as if the object is rendered locally. The opposite function is applied in case the zoom factor is less than 1.0 (wideangle).

In an embodiment, the parameter R has a reverse meaning, i.e., objects outside the sphere defined by the radius R and are rendered by the client and those within the sphere are rendered by the server. This may be desirable because closer objects need to be rendered at a higher quality and require higher processing capabilities that is available at the server. Whereas the farther objects are rendered at the client due to lower processing requirements.

In an embodiment of the above embodiment, the value of R is chosen so that reprojection needed or reprojection errors of the frame rendered at SRS are minimized.

In an embodiment, the local rendering of certain objects (e.g., interactive objects) applies to all objects in the FoV and is not limited to a particular region defined by a distance parameter R. In this case, R can be set to −1 in the configuration. Alternatively, a new flag may be used to signal UE rendering capability.

In an embodiment, the area used for determining local rendering of certain objects is defined by a shape other than a sphere. In this case, a different parameter(s) may be defined instead of the distance R to define the shape. In an embodiment, the area is not centered at the position of the viewer (XR device) but some other position (x, y, z).

In an embodiment, local rendering (or remote rendering, if R has a reverse meaning) may be applied only for the objects inside the central field of view of the user. Other objects may be present inside the user's viewport lying at the peripheries of the user's FoV and thus perceived with a reduced degree of visual acuity since the resolution of the human eye is the highest at the fixation point and quickly decreases towards the edges of the FoV. Therefore, artefacts in such objects (reduced quality, latency) would be less noticeable to the user. These could be rendered remotely (locally).

In an embodiment, the parameter R is based on Level of Detail (LoD) tiers or range in the scene being rendered. R may correspond to a LoD threshold.

The parameter R1 can be less than R2. In another embodiment, R2 is less than R1. In an embodiment R1 is used when the condition is true, and R2 is used when the condition is false. In another embodiment, R1 is used when the condition is false, and R2 is used when the condition is true. In an embodiment, a condition triggers the use of R1 and another condition triggers the use of R2. In an embodiment, the semantics of the condition are expanded such that the overlapping areas of S1 and S2 are only used for preferential rendering when R1 is being used, assuming R1 is smaller than R2. The reverse also applies, i.e., the overlapping areas of S1 and S2 are only used for preferential rendering when R2 is being used, assuming R2 is smaller than R1.

In the present document the terms client, UE and SRC are used interchangeably. Also, the terms server and SRS are used interchangeably.

The examples described herein are relevant, but not limited to 3GPP work on split rendering (e.g., SR_MSE and IBACS Work Items).

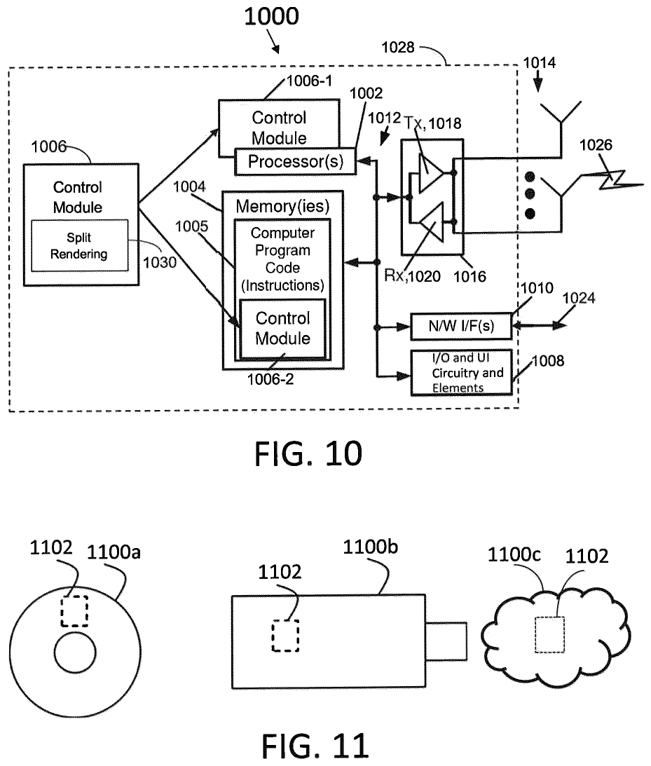

FIG. 10 is an example apparatus 1000, which may be implemented in hardware, configured to implement the examples described herein. The apparatus 1000 comprises at least one processor 1002 (e.g. an FPGA and/or CPU), one or more memories 1004 including computer program code 1005, the computer program code 1005 having instructions to carry out the methods described herein, wherein the at least one memory 1004 and the computer program code 1005 are configured to, with the at least one processor 1002, cause the apparatus 1000 to implement circuitry, a process, component, module, or function (implemented with control module 1006) to implement the examples described herein. The memory 1004 may be a non-transitory memory, a transitory memory, a volatile memory (e.g. RAM), or a non-volatile memory (e.g. ROM).

Split rendering 1030 may implement the examples described herein directed to split rendering with local rendering of interactive objects.

The apparatus 1000 includes a display and/or I/O interface 1008, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1000 includes one or more communication e.g. network (N/W) interfaces (I/F(s)) 1010. The communication I/F(s) 1010 may be wired and/or wireless and communicate over the Internet/other network(s) via any communication technique including via one or more links 1024. The link(s) 1024 may be the link(s) 131 and/or 176 from FIG. 1. The link(s) 131 and/or 176 from FIG. 1 may also be implemented using transceiver(s) 1016 and corresponding wireless link(s) 1026. The communication I/F(s) 1010 may comprise one or more transmitters or one or more receivers.

The transceiver 1016 comprises one or more transmitters 1018 and one or more receivers 1020. The transceiver 1016 and/or communication I/F(s) 1010 may comprise standard well-known components such as an amplifier, filter, frequency-converter, (de) modulator, and encoder/decoder circuitries and one or more antennas, such as antennas 1014 used for communication over wireless link 1026.

The control module 1006 of the apparatus 1000 comprises one of or both parts 1006-1 and/or 1006-2, which may be implemented in a number of ways. The control module 1006 may be implemented in hardware as control module 1006-1, such as being implemented as part of the one or more processors 1002. The control module 1006-1 may be implemented also as an integrated circuit or through other hardware such as a programmable gate array. In another example, the control module 1006 may be implemented as control module 1006-2, which is implemented as computer program code (having corresponding instructions) 1005 and is executed by the one or more processors 1002. For instance, the one or more memories 1004 store instructions that, when executed by the one or more processors 1002, cause the apparatus 1000 to perform one or more of the operations as described herein. Furthermore, the one or more processors 1002, the one or more memories 1004, and example algorithms (e.g., as flowcharts and/or signaling diagrams), encoded as instructions, programs, or code, are means for causing performance of the operations described herein.

The apparatus 1000 to implement the functionality of control 1006 may be UE 110, RAN node 170 (e.g. gNB), or network element(s) 190 (e.g. LMF 190). Thus, processor 1002 may correspond to processor(s) 120, processor(s) 152 and/or processor(s) 175, memory 1004 may correspond to one or more memories 125, one or more memories 155 and/or one or more memories 171, computer program code 1005 may correspond to computer program code 123, computer program code 153, and/or computer program code 173, control module 1006 may correspond to module 140-1, module 140-2, module 150-1, and/or module 150-2, and communication I/F(s) 1010 and/or transceiver 1016 may correspond to transceiver 130, antenna(s) 128, transceiver 160, antenna(s) 158, N/W I/F(s) 161, and/or N/W I/F(s) 180. Alternatively, apparatus 1000 and its elements may not correspond to either of UE 110, RAN node 170, or network element(s) 190 and their respective elements, as apparatus 1000 may be part of a self-organizing/optimizing network (SON) node or other node, such as a node in a cloud.

Apparatus 1000 may also correspond to SRS 212, SWAP server 304, XR device 612, XR device 712, or XR device 812.

The apparatus 1000 may also be distributed throughout the network (e.g. 100) including within and between apparatus 1000 and any network element (such as a network control element (NCE) 190 and/or the RAN node 170 and/or UE 110).

Interface 1012 enables data communication and signaling between the various items of apparatus 1000, as shown in FIG. 10. For example, the interface 1012 may be one or more buses such as address, data, or control buses, and may include any interconnection mechanism, such as a series of lines on a motherboard or integrated circuit, fiber optics or other optical communication equipment, and the like. Computer program code (e.g. instructions) 1005, including control 1006 may comprise object-oriented software configured to pass data or messages between objects within computer program code 1005. The apparatus 1000 need not comprise each of the features mentioned, or may comprise other features as well. The various components of apparatus 1000 may at least partially reside in a common housing 1028, or a subset of the various components of apparatus 1000 may at least partially be located in different housings, which different housings may include housing 1028.

FIG. 11 shows a schematic representation of non-volatile memory media 1100a (e.g. computer/compact disc (CD) or digital versatile disc (DVD)) and 1100b (e.g. universal serial bus (USB) memory stick) and 1100c (e.g. cloud storage for downloading instructions and/or parameters 1102 or receiving emailed instructions and/or parameters 1102) storing instructions and/or parameters 1102 which when executed by a processor allows the processor to perform one or more of the steps of the methods described herein. Instructions and/or parameters 1102 may represent a non-transitory computer readable medium.

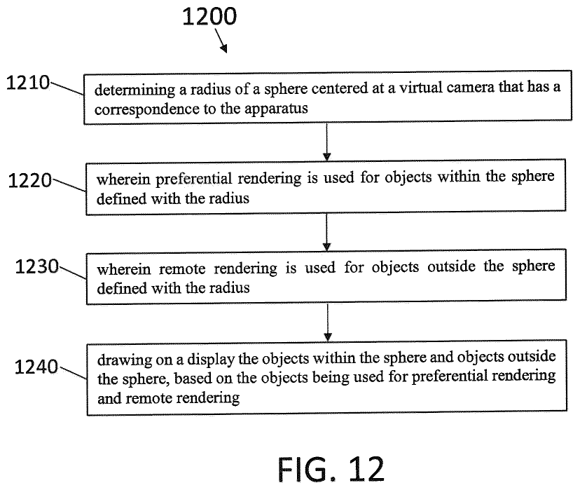

FIG. 12 is an example method 1200, based on the example embodiments described herein. At 1210, the method includes determining a radius of a sphere centered at a virtual camera that has a correspondence to the apparatus. At 1220, the method includes wherein preferential rendering is used for objects within the sphere defined with the radius. At 1230, the method includes wherein remote rendering is used for objects outside the sphere defined with the radius. At 1240, the method includes drawing on a display the objects within the sphere and objects outside the sphere, based on the objects being used for preferential rendering and remote rendering. Method 1200 may be performed with UE 110, split-rendering client 216, XR device 612, XR device 712, XR device 812, or apparatus 1000.

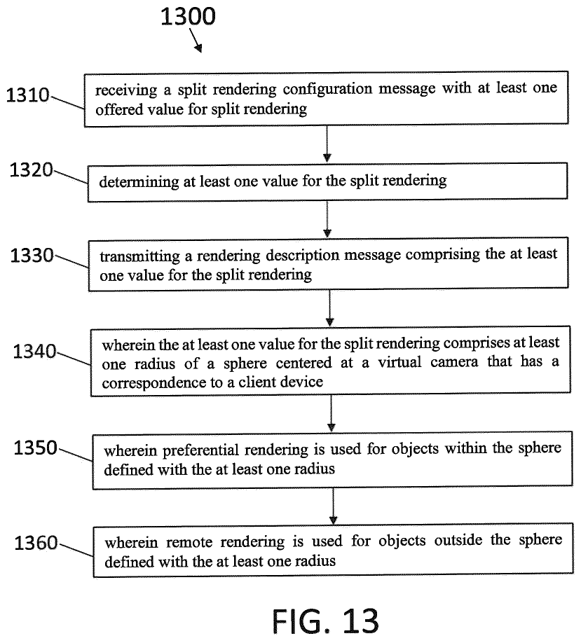

FIG. 13 is an example method 1300, based on the example embodiments described herein. At 1310, the method includes receiving a split rendering configuration message with at least one offered value for split rendering. At 1320, the method includes determining at least one value for the split rendering. At 1330, the method includes transmitting a rendering description message comprising the at least one value for the split rendering. At 1340, the method includes wherein the at least one value for the split rendering comprises at least one radius of a sphere centered at a virtual camera that has a correspondence to a client device. At 1350, the method includes wherein preferential rendering is used for objects within the sphere defined with the at least one radius. At 1360, the method includes wherein remote rendering is used for objects outside the sphere defined with the at least one radius. Method 1300 may be performed with DN 202, RTC AS 302, split-rendering server 212, or apparatus 1000.

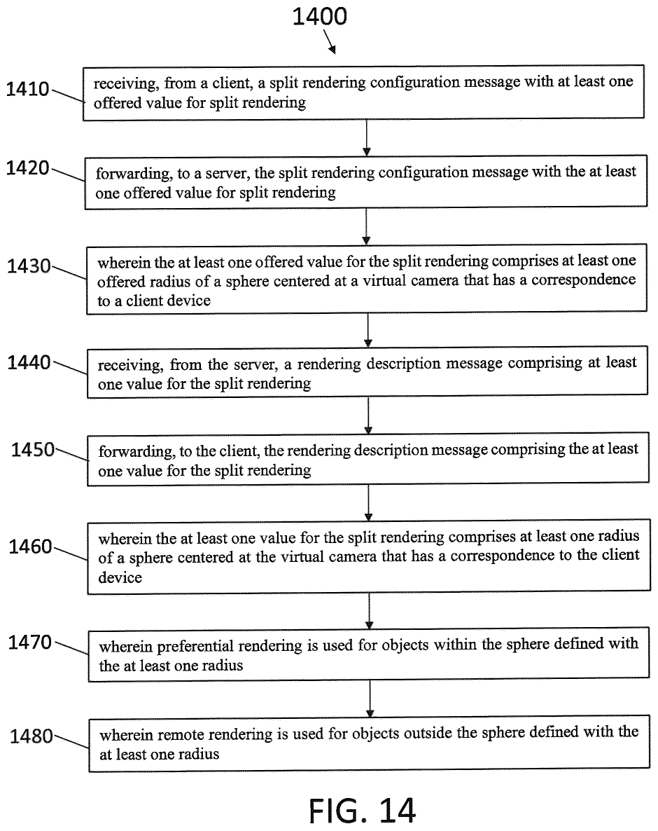

FIG. 14 is an example method 1400, based on the example embodiments described herein. At 1410, the method includes receiving, from a client, a split rendering configuration message with at least one offered value for split rendering. At 1420, the method includes forwarding, to a server, the split rendering configuration message with the at least one offered value for split rendering. At 1430, the method includes wherein the at least one offered value for the split rendering comprises at least one offered radius of a sphere centered at a virtual camera that has a correspondence to a client device. At 1440, the method includes receiving, from the server, a rendering description message comprising at least one value for the split rendering. At 1450, the method includes forwarding, to the client, the rendering description message comprising the at least one value for the split rendering. At 1460, the method includes wherein the at least one value for the split rendering comprises at least one radius of a sphere centered at the virtual camera that has a correspondence to the client device. At 1470, the method includes wherein preferential rendering is used for objects within the sphere defined with the at least one radius. At 1480, the method includes wherein remote rendering is used for objects outside the sphere defined with the at least one radius. Method 1400 may be performed with RTC AS 302, SWAP server 304, or apparatus 1000.

The following examples are provided and described herein.

Example 1. An apparatus including: at least one processor; and at least one memory storing instructions that, when executed by the at least one processor, cause the apparatus at least to: determine a radius of a sphere centered at a virtual camera that has a correspondence to the apparatus; wherein preferential rendering is used for objects within the sphere defined with the radius; wherein remote rendering is used for objects outside the sphere defined with the radius; and draw on a display the objects within the sphere and objects outside the sphere, based on the objects being used for preferential rendering and remote rendering.

Example 2. The apparatus of example 1, wherein the instructions, when executed by the at least one processor, cause the apparatus at least to: determine a restricted field of view relative to the radius, wherein preferential rendering is used for objects within the restricted field of view.

Example 3. The apparatus of example 2, wherein the restricted field of view is based on one or more of: a gaze of a user of the apparatus, or an application state, or an action of another user in a mixed reality experience shared with the apparatus, or a pose of another user in a mixed reality experience shared with the apparatus, or an environmental condition, or a position of at least one light source, or a movement of at least one object.

Example 4. The apparatus of any of examples 1 to 3, wherein the instructions, when executed by the at least one processor, cause the apparatus at least to: determine a first radius of a first sphere centered at the virtual camera that has a correspondence to the apparatus; and determine a second radius of a second sphere centered at the virtual camera that has a correspondence to the apparatus.

Example 5. The apparatus of example 4, wherein remote rendering is used for objects outside the second sphere defined with the second radius.

Example 6. The apparatus of any of examples 4 to 5, wherein the second radius is larger than the first radius.

Example 7. The apparatus of any of examples 4 to 6, wherein: preferential rendering is used for objects within the first sphere defined with the first radius when a condition is not met; preferential rendering is used for objects within the second sphere defined with the second radius when the condition is met.

Example 8. The apparatus of any of examples 4 to 7, wherein at least one object within the second sphere defined with the second radius is outside the first sphere defined with the first radius.

Example 9. The apparatus of any of examples 7 to 8, wherein the condition comprises eye tracking being enabled with the apparatus.

Example 10. The apparatus of any of examples 4 to 9, wherein: preferential rendering is used for objects within the first sphere defined with the first radius when a condition is met; preferential rendering is used for objects within the second sphere defined with the second radius when the condition is not met.

Example 11. The apparatus of 10, wherein the condition comprises eye tracking being enabled with the apparatus.

Example 12. The apparatus of any of examples 4 to 11, wherein the instructions, when executed by the at least one processor, cause the apparatus at least to: determine that a space defined with the second radius of the second sphere is used for preferential rendering during focused viewing; and determine that a space defined with the first radius of the first sphere is used for preferential rendering during unfocused viewing.

Example 13. The apparatus of example 12, wherein focused viewing comprises a gaze of a user intersecting an object, wherein the gaze of the user intersecting the object is determined with gaze tracking.

Example 14. The apparatus of any of examples 12 to 13, wherein at least one object within the space defined with the second radius is outside the space defined with the first radius of the first sphere.

Example 15. The apparatus of any of examples 4 to 14, wherein the instructions, when executed by the at least one processor, cause the apparatus at least to: determine a restricted field of view relative to the first radius or the second radius, wherein preferential rendering is used for objects within the restricted field of view.

Example 16. The apparatus of example 15, wherein the restricted field of view is based on one or more of: a gaze of a user of the apparatus, or an application state, or an action of another user in a mixed reality experience shared with the apparatus, or a pose of another user in a mixed reality experience shared with the apparatus, or an environmental condition, or a position of at least one light source, or a movement of at least one object.

Example 17. The apparatus of any of examples 1 to 16, wherein the instructions, when executed by the at least one processor, cause the apparatus at least to: determine a seamless adaptation parameter that indicates that an object is rendered at a split rendering client when at least one requirement for preferential rendering is met, and that the object is rendered at a split rendering server when the at least one requirement for preferential rendering is not met, without use of additional signaling between the split rendering client and the split rendering server.

Example 18. The apparatus of any of examples 1 to 17, wherein the instructions, when executed by the at least one processor, cause the apparatus at least to: determine a type of preferential rendering to be used, wherein the type of preferential rendering comprises one of: local rendering where objects are rendered on a client, or level of detail rendering where objects with a higher level of detail are rendered, or composition layer rendering where objects are rendered as a separate composition layer, or remote rendering when level of detail rendering is used.

Example 19. The apparatus of any of examples 1 to 18, wherein the instructions, when executed by the at least one processor, cause the apparatus at least to: transmit a split rendering configuration message with at least one offered value for split rendering; receive a rendering description message comprising at least one value for the split rendering; and render objects based on the at least one value for the split rendering.

Example 20. The apparatus of any of examples 1 to 19, wherein the instructions, when executed by the at least one processor, cause the apparatus at least to: transmit pose feedback signaling indicating that the apparatus is capable of receiving a real-time transport protocol header extension with a list of object identifiers for local rendering; and receive rendered media from a server, the rendered media comprising object identifiers within a real-time transport protocol header extension.

Example 21. The apparatus of any of examples 1 to 20, wherein preferential rendering comprises at least one or more of: rendering the objects within the sphere defined with the radius locally at the apparatus, and the objects outside the sphere defined with the radius being rendered at a split rendering server, or the objects within the sphere defined with the radius being rendered at a split rendering server as a composition layer with higher warp sensitivity, or the objects within the sphere defined with the radius being rendered at a quality higher than the objects outside the sphere defined with the radius, and higher than any other objects that are not within the sphere defined with the radius.

Example 22. The apparatus of any of examples 1 to 21, wherein the apparatus comprises an extended reality device, or the extended reality device comprises the apparatus.

Example 23. An apparatus including: at least one processor; and at least one memory storing instructions that, when executed by the at least one processor, cause the apparatus at least to: receive a split rendering configuration message with at least one offered value for split rendering; determine at least one value for the split rendering; and transmit a rendering description message comprising the at least one value for the split rendering; wherein the at least one value for the split rendering comprises at least one radius of a sphere centered at a virtual camera that has a correspondence to a client device; wherein preferential rendering is used for objects within the sphere defined with the at least one radius; wherein remote rendering is used for objects outside the sphere defined with the at least one radius.

Example 24. The apparatus of example 23, wherein the instructions, when executed by the at least one processor, cause the apparatus at least to: determine a restricted field of view relative to the at least one radius, wherein preferential rendering is used for objects within the restricted field of view.

Example 25. The apparatus of any of examples 23 to 24, wherein the instructions, when executed by the at least one processor, cause the apparatus at least to: determine a first radius of a first sphere centered at the virtual camera that has a correspondence to the client device; and determine a second radius of a second sphere centered at the virtual camera that has a correspondence to the client device.

Example 26. The apparatus of example 25, wherein at least one object within the second sphere defined with the second radius is outside the first sphere defined with the first radius.

Example 27. The apparatus of any of examples 25 to 26, wherein remote rendering is used for objects outside the second sphere defined with the second radius.

Example 28. The apparatus of any of examples 25 to 27, wherein the second radius is larger than the first radius.

Example 29. The apparatus of any of examples 25 to 28, wherein: preferential rendering is used for objects within the first sphere defined with the first radius when a condition is not met; and preferential rendering is used for objects within the second sphere defined with the second radius when the condition is met.

Example 30. The apparatus of example 29, wherein the condition comprises eye tracking being enabled with the client device.

Example 31. The apparatus of any of examples 25 to 30, wherein: preferential rendering is used for objects within the first sphere defined with the first radius when a condition is met; preferential rendering is used for objects within the second sphere defined with the second radius when the condition is not met.

Example 32. The apparatus of example 31, wherein the condition comprises eye tracking being enabled with the client device.

Example 33. The apparatus of any of examples 23 to 32, wherein the instructions, when executed by the at least one processor, cause the apparatus at least to: receive pose feedback signaling indicating that the client device is capable of receiving a real-time transport protocol header extension with a list of object identifiers for local rendering; and deliver rendered media to the client device, the rendered media comprising object identifiers within a real-time transport protocol header extension.

Example 34. The apparatus of any of examples 23 to 33, wherein preferential rendering comprises at least one or more of: the objects within the sphere defined with the radius being rendered locally at the client device, and rendering the objects outside the sphere defined with the radius at the apparatus, or rendering the objects within the sphere defined with the radius at the apparatus as a composition layer with higher warp sensitivity, or the objects within the sphere defined with the radius being rendered at a quality higher than the objects outside the sphere defined with the radius, and higher than any other objects that are not within the sphere defined with the radius.

Example 35. The apparatus of any of examples 23 to 34, wherein the apparatus comprises a split rendering server, or the split rendering server comprises the apparatus.

Example 36. An apparatus including: at least one processor; and at least one memory storing instructions that, when executed by the at least one processor, cause the apparatus at least to: receive, from a client, a split rendering configuration message with at least one offered value for split rendering; forward, to a server, the split rendering configuration message with the at least one offered value for split rendering; wherein the at least one offered value for the split rendering comprises at least one offered radius of a sphere centered at a virtual camera that has a correspondence to a client device; receive, from the server, a rendering description message comprising at least one value for the split rendering; and forward, to the client, the rendering description message comprising the at least one value for the split rendering; wherein the at least one value for the split rendering comprises at least one radius of a sphere centered at the virtual camera that has a correspondence to the client device; wherein preferential rendering is used for objects within the sphere defined with the at least one radius; wherein remote rendering is used for objects outside the sphere defined with the at least one radius.

Example 37. The apparatus of example 36, wherein: the at least one offered value for split rendering comprises an offered restricted field of view relative to the at least one offered radius; and the at least one value for the split rendering comprises a restricted field of view relative to the at least one radius, wherein preferential rendering is used for objects within the restricted field of view.

Example 38. The apparatus of any of examples 36 to 37, wherein: the at least one offered value for split rendering comprises a first offered radius of a first offered sphere centered at the virtual camera that has a correspondence to the client device, and a second offered radius of a second offered sphere centered at the virtual camera that has a correspondence to the client device; and the at least one value for the split rendering comprises a first radius of a first sphere centered at the virtual camera that has a correspondence to the client device, and a second radius of a second sphere centered at the virtual camera that has a correspondence to the client device.

Example 39. The apparatus of example 38, wherein remote rendering is used for objects outside the second sphere defined with the second radius.

Example 40. The apparatus of any of examples 38 to 39, wherein the second radius is larger than the first radius.

Example 41. The apparatus of any of examples 38 to 40, wherein: preferential rendering is used for the objects within the first sphere defined with the first radius when a condition is not met; preferential rendering is used for objects within the second sphere defined with the second radius when the condition is met.

Example 42. The apparatus of any of examples 38 to 41, wherein: preferential rendering is used for the objects within the first sphere defined with the first radius when a condition is met; preferential rendering is used for objects within the second sphere defined with the second radius when the condition is not met.

Example 43. The apparatus of example 41 or 42, wherein the condition comprises eye tracking being enabled with the client device.

Example 44. The apparatus of any of examples 38 to 43, wherein preferential rendering comprises at least one or more of: the objects within the sphere defined with the radius being rendered locally at a user equipment, and the objects outside the sphere defined with the radius being rendered at a split rendering server, or the objects within the sphere defined with the radius being rendered at a split rendering server as a composition layer with higher warp sensitivity, or the objects within the sphere defined with the radius being rendered at a quality higher than the objects outside the sphere defined with the radius, and higher than any other objects that are not within the sphere defined with the radius.

Example 45. The apparatus of any of examples 38 to 44, wherein at least one object within the second sphere defined with the second radius is outside the first sphere defined with the first radius.

Example 46. The apparatus of any of examples 36 to 45, wherein the apparatus comprises a simple web real time communication application protocol server, or the simple web real time communication application protocol comprises the apparatus.

Example 47. A method including: determining a radius of a sphere centered at a virtual camera that has a correspondence to the apparatus; wherein preferential rendering is used for objects within the sphere defined with the radius; wherein remote rendering is used for objects outside the sphere defined with the radius; and drawing on a display the objects within the sphere and objects outside the sphere, based on the objects being used for preferential rendering and remote rendering.

Example 48. A method including: receiving a split rendering configuration message with at least one offered value for split rendering; determining at least one value for the split rendering; and transmitting a rendering description message comprising the at least one value for the split rendering; wherein the at least one value for the split rendering comprises at least one radius of a sphere centered at a virtual camera that has a correspondence to a client device; wherein preferential rendering is used for objects within the sphere defined with the at least one radius; wherein remote rendering is used for objects outside the sphere defined with the at least one radius.

Example 49. A method including: receiving, from a client, a split rendering configuration message with at least one offered value for split rendering; forwarding, to a server, the split rendering configuration message with the at least one offered value for split rendering; wherein the at least one offered value for the split rendering comprises at least one offered radius of a sphere centered at a virtual camera that has a correspondence to a client device; receiving, from the server, a rendering description message comprising at least one value for the split rendering; and forwarding, to the client, the rendering description message comprising the at least one value for the split rendering; wherein the at least one value for the split rendering comprises at least one radius of a sphere centered at the virtual camera that has a correspondence to the client device; wherein preferential rendering is used for objects within the sphere defined with the at least one radius; wherein remote rendering is used for objects outside the sphere defined with the at least one radius.

Example 50. An apparatus including: means for determining a radius of a sphere centered at a virtual camera that has a correspondence to the apparatus; wherein preferential rendering is used for objects within the sphere defined with the radius; wherein remote rendering is used for objects outside the sphere defined with the radius; and means for drawing on a display the objects within the sphere and objects outside the sphere, based on the objects being used for preferential rendering and remote rendering.

Example 51. An apparatus including: means for receiving a split rendering configuration message with at least one offered value for split rendering; means for determining at least one value for the split rendering; and means for transmitting a rendering description message comprising the at least one value for the split rendering; wherein the at least one value for the split rendering comprises at least one radius of a sphere centered at a virtual camera that has a correspondence to a client device; wherein preferential rendering is used for objects within the sphere defined with the at least one radius; wherein remote rendering is used for objects outside the sphere defined with the at least one radius.

Example 52. An apparatus including: means for receiving, from a client, a split rendering configuration message with at least one offered value for split rendering; means for forwarding, to a server, the split rendering configuration message with the at least one offered value for split rendering; wherein the at least one offered value for the split rendering comprises at least one offered radius of a sphere centered at a virtual camera that has a correspondence to a client device; means for receiving, from the server, a rendering description message comprising at least one value for the split rendering; and means for forwarding, to the client, the rendering description message comprising the at least one value for the split rendering; wherein the at least one value for the split rendering comprises at least one radius of a sphere centered at the virtual camera that has a correspondence to the client device; wherein preferential rendering is used for objects within the sphere defined with the at least one radius; wherein remote rendering is used for objects outside the sphere defined with the at least one radius.

Example 53. A computer readable medium including instructions stored thereon for performing at least the following: determining a radius of a sphere centered at a virtual camera that has a correspondence to the apparatus; wherein preferential rendering is used for objects within the sphere defined with the radius; wherein remote rendering is used for objects outside the sphere defined with the radius; and drawing on a display the objects within the sphere and objects outside the sphere, based on the objects being used for preferential rendering and remote rendering.

Example 54. A computer readable medium including instructions stored thereon for performing at least the following: receiving a split rendering configuration message with at least one offered value for split rendering; determining at least one value for the split rendering; and transmitting a rendering description message comprising the at least one value for the split rendering; wherein the at least one value for the split rendering comprises at least one radius of a sphere centered at a virtual camera that has a correspondence to a client device; wherein preferential rendering is used for objects within the sphere defined with the at least one radius; wherein remote rendering is used for objects outside the sphere defined with the at least one radius.

Example 55. A computer readable medium including instructions stored thereon for performing at least the following: receiving, from a client, a split rendering configuration message with at least one offered value for split rendering; forwarding, to a server, the split rendering configuration message with the at least one offered value for split rendering; wherein the at least one offered value for the split rendering comprises at least one offered radius of a sphere centered at a virtual camera that has a correspondence to a client device; receiving, from the server, a rendering description message comprising at least one value for the split rendering; and forwarding, to the client, the rendering description message comprising the at least one value for the split rendering; wherein the at least one value for the split rendering comprises at least one radius of a sphere centered at the virtual camera that has a correspondence to the client device; wherein preferential rendering is used for objects within the sphere defined with the at least one radius; wherein remote rendering is used for objects outside the sphere defined with the at least one radius.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

The term “non-transitory,” as used herein, is a limitation of the medium itself (i.e., tangible, not a signal) as opposed to a limitation on data storage persistency (e.g., RAM vs. ROM).

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended/combined with each other or with other characters using e.g. a dash, hyphen, slash, letter, or number, and may be case insensitive):
2D two dimensional
3GPP third generation partnership project
4G fourth generation
5G fifth generation
5GC 5G core network
AF application function
AMF access and mobility management function
AP application provider
API application programming interface
APP application-defined RTCP Packet
AR augmented reality
ARR azure remote rendering
AS application server
ASIC application-specific integrated circuit
attr attribute
BNF Backus normal form
CD compact/computer disc
config configure, configuration
CPU central processing unit
CU central unit or centralized unit
DN data network
DSP digital signal processor
DU distributed unit
DVD digital versatile disc
EDGE enhanced data rates for GSM evolution
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
enum enumerated
E-UTRA evolved UMTS terrestrial radio access, i.e., the LTE radio access technology
E-UTRAN E-UTRA network extmap extension map
F1 interface between the CU and the DU
FoV field of view
FPGA field-programmable gate array
gNB base station for 5G/NR, i.e., a node providing NR user plane and control plane protocol terminations towards the UE, and connected via the NG interface to the 5GC
GSM global system for mobile communication
HE header extension
IAB integrated access and backhaul
IBACS IMS-based AR conversational services
Id, ID, id identifier
I/F interface
IMS IP multimedia subsystem
I/O input/output
IP internet protocol
JSON javascript object notation
LMF location management function
LOD level of detail
LTE long term evolution (4G)
MAC medium access control
MF media function
MME mobility management entity
MRO mobility robustness optimization
MSE media service enabler
MTSI multimedia telephony service over IMS
NCE network control element
ng or NG new generation
ng-eNB new generation eNB
NG-RAN new generation radio access network
NR new radio
N/W network
OAM operations, administration and maintenance
PDA personal digital assistant
PDCP packet data convergence protocol
PHY physical layer
QoE quality of experience
RAM random access memory
RAN radio access network
ref reference
RFC request for comments
RLC radio link control
ROM read-only memory
RRC radio resource control
RTC real time communication
RTCP real-time transport control protocol
RTP real-time transport protocol
RU radio unit
Rx receive, or receiver, or reception
SDAP service data adaptation protocol
SDP session description protocol
SGW serving gateway
SIP session initiation protocol
SMF session management function
SON self-organizing/optimizing network
SR split rendering
SRC split rendering client
SRS split rendering server
SWAP Simple WebRTC Application Protocol
TRP transmission and reception point
TS technical specification
Tx transmit, or transmitter, or transmission
UAV unmanned aerial vehicle
UE user equipment (e.g., a wireless, typically mobile device)
UI user interface
UMTS Universal Mobile Telecommunications System
UPF user plane function
URN uniform resource name
USB universal serial bus
UTRAN UMTS terrestrial radio access network
WebRTC web real time communication
X2 network interface between RAN nodes and between RAN and the core network
Xn network interface between NG-RAN nodes
XR extended reality

1. An apparatus comprising:
at least one processor; and
at least one memory storing instructions that, when executed by the at least one processor, cause the apparatus at least to:
determine a radius of a sphere centered at a virtual camera that has a correspondence to the apparatus;
wherein preferential rendering is used for objects within the sphere defined with the radius;
wherein remote rendering is used for objects outside the sphere defined with the radius; and
draw on a display the objects within the sphere and objects outside the sphere, based on the objects being used for preferential rendering and remote rendering.

2. The apparatus of claim 1, wherein the apparatus is further caused to:
determine a restricted field of view relative to the radius, wherein preferential rendering is used for objects within the restricted field of view.

3. The apparatus of claim 2, wherein the restricted field of view is based on one or more of:
a gaze of a user of the apparatus, or
an application state, or
an action of another user in a mixed reality experience shared with the apparatus, or
a pose of another user in a mixed reality experience shared with the apparatus, or
an environmental condition, or
a position of at least one light source, or
a movement of at least one object.

4.-16. (canceled)

17. The apparatus of claim 1, wherein the apparatus is further caused to:
determine a seamless adaptation parameter that indicates that an object is rendered at a split rendering client when at least one requirement for preferential rendering is met, and that the object is rendered at a split rendering server when the at least one requirement for preferential rendering is not met, without use of additional signaling between the split rendering client and the split rendering server.

18. The apparatus of claim 1, wherein the apparatus is further caused to:
determine a type of preferential rendering to be used, wherein the type of preferential rendering comprises one of: local rendering where objects are rendered on a client, or level of detail rendering where objects with a higher level of detail are rendered, or composition layer rendering where objects are rendered as a separate composition layer, or remote rendering when level of detail rendering is used.

19. The apparatus of claim 1, wherein the apparatus is further caused to:
transmit a split rendering configuration message with at least one offered value for split rendering;
receive a rendering description message comprising at least one value for the split rendering; and
render objects based on the at least one value for the split rendering.

20. The apparatus of claim 1, wherein the apparatus is further caused to:
transmit pose feedback signaling indicating a list of object identifiers used for preferential rendering; and
receive rendered media from a server, the rendered media comprising object identifiers for objects that were rendered by the server within a real-time transport protocol header extension.

21. The apparatus of claim 1, wherein preferential rendering comprises at least one or more of:
rendering the objects within the sphere defined with the radius locally at the apparatus, and the objects outside the sphere defined with the radius being rendered at a split rendering server, or
the objects within the sphere defined with the radius being rendered at a split rendering server as a composition layer with higher warp sensitivity, or
the objects within the sphere defined with the radius being rendered at a quality higher than the objects outside the sphere defined with the radius, and higher than any other objects that are not within the sphere defined with the radius.

22. The apparatus of claim 1, wherein the apparatus comprises an extended reality device, or the extended reality device comprises the apparatus.

23. An apparatus comprising:
at least one processor; and
at least one memory storing instructions that, when executed by the at least one processor, cause the apparatus at least to:
receive a split rendering configuration message with at least one offered value for split rendering;
determine at least one value for the split rendering; and
transmit a rendering description message comprising the at least one value for the split rendering;
wherein the at least one value for the split rendering comprises at least one radius of a sphere centered at a virtual camera that has a correspondence to a client device;
wherein preferential rendering is used for objects within the sphere defined with the at least one radius;
wherein remote rendering is used for objects outside the sphere defined with the at least one radius.

24. The apparatus of claim 23, wherein the apparatus is further caused to:
determine a restricted field of view relative to the at least one radius, wherein preferential rendering is used for objects within the restricted field of view.

25.-32. (canceled)

33. The apparatus of claim 23, wherein the apparatus is further caused to:
receive pose feedback signaling indicating a list of object identifiers used for preferential rendering; and
deliver rendered media to the client device, the rendered media comprising object identifiers for objects that were rendered by the apparatus within a real-time transport protocol header extension.

34. The apparatus of claim 23, wherein preferential rendering comprises at least one or more of:
the objects within the sphere defined with the radius being rendered locally at the client device, and rendering the objects outside the sphere defined with the radius at the apparatus, or
rendering the objects within the sphere defined with the radius at the apparatus as a composition layer with higher warp sensitivity, or
the objects within the sphere defined with the radius being rendered at a quality higher than the objects outside the sphere defined with the radius, and higher than any other objects that are not within the sphere defined with the radius.

35. The apparatus of claim 23, wherein the apparatus comprises a split rendering server, or the split rendering server comprises the apparatus.

36. An apparatus comprising:
at least one processor; and
at least one memory storing instructions that, when executed by the at least one processor, cause the apparatus at least to:
receive, from a client, a split rendering configuration message with at least one offered value for split rendering;
forward, to a server, the split rendering configuration message with the at least one offered value for split rendering;
wherein the at least one offered value for the split rendering comprises at least one offered radius of a sphere centered at a virtual camera that has a correspondence to a client device;
receive, from the server, a rendering description message comprising at least one value for the split rendering; and
forward, to the client, the rendering description message comprising the at least one value for the split rendering;
wherein the at least one value for the split rendering comprises at least one radius of a sphere centered at the virtual camera that has a correspondence to the client device;
wherein preferential rendering is used for objects within the sphere defined with the at least one radius;
wherein remote rendering is used for objects outside the sphere defined with the at least one radius.

37. The apparatus of claim 36, wherein:
the at least one offered value for split rendering comprises an offered restricted field of view relative to the at least one offered radius, and
the at least one value for the split rendering comprises a restricted field of view relative to the at least one radius, wherein preferential rendering is used for objects within the restricted field of view.

38.-45. (canceled)

46. The apparatus of claim 36, wherein the apparatus comprises a simple web real time communication application protocol server, or the simple web real time communication application protocol comprises the apparatus.

47.-55. (canceled)

56. The apparatus of claim 1, wherein:
objects with a high-level of interaction are rendered at the apparatus, and
a level of interaction of an object is determined based on actions comprising one or more of eye gaze, or controller input, or a hand gesture.

57. The apparatus of claim 1, wherein objects that have predictable motion or slow response to actions are rendered at a server.

58. The apparatus of claim 1, wherein:
rendering of at least one object changes from rendering of the at least one object at a server to rendering of the at least one object at the apparatus, when a level of interaction with the at least one object increases, and
rendering of the at least one object changes from rendering of the at least one object at the apparatus to rendering of the at least one object at the server, when a level of interaction with the at least one object decreases.
